(19) United States
(12) Patent Application Publication
(10) Pub. No.: US 2017/0100924 A1
(43) Pub. Date: Apr. 13, 2017

(54) A PROCESS FOR PRODUCING A SECURITY FILM AND A SECURITY FILM

(71) Applicant: INNOVIA FILMS LIMITED, Wigton, Cumbria (GB)

(72) Inventors: Simon READ, Wigton, Cumbria (GB); Thierry GAVEL, Wigton, Cumbria (GB)

(73) Assignee: INNOVIA FILMS LIMITED, Wigton, Cumbria (GB)

(21) Appl. No.: 15/306,951

(22) PCT Filed: Jun. 26, 2015
(86) PCT No.: PCT/IB2015/054816

§ 371 Date: Oct. 26, 2016

(30) Foreign Application Priority Data
Jun. 30, 2014 (GB) 1411627.1

(51) Int. Cl. B32B 38/00; B32B 38/06; B32B 7/12; B32B 15/08; B32B 15/20; B42D 25/21; B42D 25/29; B42D 25/373; B42D 25/364; B42D 25/328; B42D 25/47; B42D 25/425; B42D 25/445; B42D 25/41; B32B 37/12

(52) U.S. Cl. CPC B32B 38/0008; B32B 37/12; B32B 38/06; B32B 38/145; B32B 7/12; B32B 15/08; B32B 15/20; B42D 25/21; B42D 25/29; B42D 25/373; B42D 25/364; B42D 25/328; B42D 25/47; B42D 25/425; B42D 25/445; B42D 25/41; B32B 2425/00

(57) ABSTRACT

The invention concerns a process for producing a security film, comprising:
a. forming a polymeric film substrate having first and second surfaces;
b. plasma treating at least one surface of the polymeric film substrate using a modified atmosphere plasma treatment, wherein the modified atmosphere comprises at least one inert carrier gas and at least one functional material selected from:
i. one or more oxidising fluids;
ii. one or more reducing fluids; and
iii. one or more polar fluids with the capacity to form ionic or covalent bonds with the at least one surface of the polymeric film substrate,
wherein those oxidising fluids with a relative dielectric strength less than that of air, where present, are in the modified atmosphere in an amount less than 40% by weight or by volume; and
c. contacting a foil with the at least one plasma treated surface of the polymeric film substrate such that the foil adheres to the polymeric film substrate.

This application is a national stage application of International Patent Application No. PCT/IB2015/054816, filed Jun. 26, 2015, which claims priority to Great Britain patent Application No. 1411627.1, filed Jun. 30, 2016. The entirety of the aforementioned applications is incorporated herein by reference.

### FIELD

The present invention is concerned with the surface treatment of substrates, particularly polymeric film substrates, to improve their adherence to other materials.

### BACKGROUND

Polymeric films are increasingly being used as substrates in fields where security, authentication, identification and anti-counterfeiting are important. Polymer-based products in such areas include, for example, bank notes, credit cards, important documents (e.g. ID materials including passports and land title, share and educational certificates), films for packaging high-value goods for anti-counterfeiting purposes, security labels and security cards.

Polymeric films have advantages in terms of security, functionality, durability, cost-effectiveness, cleanliness, processability and environmental considerations. Arguably the most notable amongst these is the security advantage. Paper-based bank notes, for example, can be relatively easy to copy, and there is higher occurrence of counterfeit bank notes in countries with paper-based bank notes compared to those countries using polymer-based bank notes. In addition, polymer-based bank notes are longer-lasting and less-easily torn than their paper-based counterparts.

Security materials based on polymeric films have the advantage that the high temperatures used in copying machines will often cause melting or distortion of polymer base materials if counterfeiters attempt simply to copy secure materials (e.g. bank notes) using such machines. In addition, security materials based on polymeric films are amenable to the incorporation of a variety of visible and hidden security features. Since the introduction of the first polymer bank notes, security features have included optically variable devices (OVDs), opacification features, printed security features, security threads, embossing, transparent windows and diffraction gratings.

Optically variable devices (OVDs) include holograms, diffraction grating images and/or liquid crystal technology, for example. They are typically formed from a foil containing iridescent images. The foil may exhibit various optical effects, for example movement or colour changes, according to the viewing angle. A major advantage of OVDs is that they cannot be accurately replicated or reproduced without using expensive, specialist equipment—simply photocopying or scanning the OVD will not work.

In general, the foil comprises a metallised layer, for example comprising copper or aluminium. The foil usually includes an adhesive layer provided on one surface of the metallised layer. Typically, prior to application, the foil is part of a laminate structure comprising a release film, for example a polyethylene terephthalate film. The laminate structure may be formed by depositing a metallised layer onto the release film and then applying an adhesive layer to the exposed surface of the metallised layer. The current practice is to use hot foil stamping or continuous foil application to adhere the foil to a polymeric film substrate. During this process, the release film detaches from the foil after adhesion of the foil to the substrate, leaving the foil adhered to the polymeric film substrate via the adhesive layer.

However, various problems exist when applying the foil to the polymeric film substrate. For example, it is difficult to achieve the necessary adhesion of the foil to the polymeric film substrate due to the often fundamentally different nature of the two components. The delicate nature of the security features combined with poor adhesion between the foil and the polymeric film substrate, often results in parts of the foil being pulled off the polymeric film substrate when the release film is detached or the foil failing a tape adhesion test. Consequently, there is a need in the art for a process whereby foils with different characteristics, for example different compositions, shapes and sizes, can be consistently adhered to a polymeric film substrate.

It is known in the art to plasma treat film substrates to improve their adherence to other materials.

For example, US 2004/031591 describes a method for producing a multi-layered film web by joining together at least film webs and/or at least one film web and at least one coating material, wherein that surface of the at least one film web which is brought into contact with another film web or with a coating material is treated with an indirect atmospheric plasmatron, with the optional addition of a working gas to the plasma generated by the plasmatron. Where a polyolefin film is combined with a metallised or printed polyethylene terephthalate film, the polyolefin is treated with a plasma based on an oxidative working gas, for example containing a high level of oxygen or carbon dioxide.

U.S. Pat. No. 3,959,567 describes a process and apparatus for bonding shaped members without the use of an adhesive, comprising the steps of exposing the surfaces to be bonded to the low energy particles of a gas discharge plasma just before and substantially simultaneously as the members are brought together into intimate face-to-face contact; heating the members; and then compressing the heated members together. The process is used to bond a thermoplastic resin such as polyethylene or ethylene-vinyl acetate copolymer to a wide variety of materials including cellophane, polyester or aluminium foil. The gas discharge plasma is formed from helium, nitrogen, argon or air.

KR 922281 B1 describes a method for improving adhesion strength between a plastic resin and a metal film, wherein the plastic resin is treated with atmospheric pressure plasma so as to form holes with the size of 0.01 to 5 μm or embossing on the surface of the plastic resin.

KR 710909 B1 describes a method for modifying the surface of a PTFE film to increase the adhesion force between the surface of the PTFE film and a metal. The method involves positioning the PTFE film in a vacuum chamber, and maintaining the vacuum state; supplying oxygen gas into the vacuum chamber at a flow rate of 8 to 13 sccm; and forming oxygen plasma by irradiating hydrogen ion beams onto the surface of the PTFE.

It is also known in the art to use modified atmosphere dielectric barrier discharge followed by corona discharge treatment to enhance the printability of a film surface.

In our WO 2013/045930 application, a process for producing a printable film is described. The process comprises: providing a web of film; at a first location subjecting at least a first surface of the film web to a modified atmosphere dielectric barrier discharge (MADBD) treatment; winding the film web onto a reel; transporting the wound film web to a second location; unwinding the film web from the reel; and subjecting the first surface of the film to corona treatment.

In our GB 1305631.2 (GB2512357) application, a similar process for producing a food contact approvable, printable film is described. The process comprises: providing a web of film having a width of at least about 1 cm and and/or a length of at least 1 m and/or a weight of at least about 1 g and having a food-contactable surface; at a first location subjecting at least a first surface of the film web to a modified atmosphere dielectric barrier discharge (MADBD) treatment; winding the film web onto a reel; transporting the wound film web to a second location; unwinding the film web from the reel; and subjecting the first surface of the film to corona treatment.

In our GB 1305632.0 (GB2512358) application, a similar process for producing a printable film having a radiocarbon content is described. The process comprises: providing a web of film having a radiocarbon content; at a first location subjecting at least a first surface of the film web to a modified atmosphere dielectric barrier discharge (MADBD) treatment; winding the film web onto a reel; transporting the wound film web to a second location; unwinding the film web from the reel; and subjecting the first surface of the film to corona treatment.

However, there are various problems associated with the prior art processes, for example the surface of the polymeric film substrate is often deteriorated during plasma treatment as a result of the type of plasma atmosphere used. Consequently, the adhesion between the polymeric film substrate and another material, for example a foil, is reduced. Thus, there remains a need in the art for an improved process for adhering a foil to a polymeric film substrate.

### BRIEF DESCRIPTION OF THE DRAWINGS

FIG. 1 shows a graph of the adhesion score against power. From the results, it can also be seen that the preferred power range for MADBD treatment may be between about 60 and 90 W.m²/min.

### DETAILED DESCRIPTION

According to a first aspect of the present invention, there is provided a process for producing a security film, comprising:

a. forming a polymeric film substrate having first and second surfaces;

b. plasma treating at least one surface of the polymeric film substrate using a modified atmosphere plasma treatment, wherein the modified atmosphere comprises at least one inert carrier gas and at least one functional material selected from:
i. one or more oxidising fluids;
ii. one or more reducing fluids; and
iii. one or more polar fluids with the capacity to form ionic or covalent bonds with the at least one surface of the polymeric film substrate,
   wherein those oxidising fluids with a relative dielectric strength less than that of air, where present, are in the modified atmosphere in an amount of less than 40% by weight or by volume; and

c. contacting a foil with the at least one plasma treated surface of the polymeric film substrate such that the foil adheres to the polymeric film substrate.

By ‘security film’ we mean any film which may be used in a security application, including, but not limited to, bank notes, gift vouchers, credit cards, security packaging, security labels, important documents e.g. ID materials including passports and birth certificates, transport documents, and land title, share and educational certificates, and the like.

The modified atmosphere plasma treatment takes place in a modified atmosphere rather than in air. Preferably, the modified atmosphere plasma treatment is an atmospheric pressure plasma treatment, for example modified atmosphere dielectric barrier discharge (MADBD) treatment.

The inert carrier gas may comprise a noble gas, for example helium or argon, and/or nitrogen.

The one or more reducing fluids may comprise acetylene, ethylene, hydrogen and/or silane, for example.

The one or more polar fluids with the capacity to form ionic or covalent bonds with the at least one surface of the polymeric film substrate may comprise ammonia and/or sulphur hexafluoride, for example.

The one or more oxidising fluids may comprise oxygen, ozone, carbon dioxide, carbon monoxide, a nitric oxide, a nitrous oxide, sulphur oxide, sulphur dioxide and/or sulphur trioxide, for example.

It may be advantageous to include one or more oxidising fluids in the modified atmosphere since they may help to prevent the build-up of soot on the surface of the polymeric film substrate.

Where oxidising fluids with a relative dielectric strength less than that of air are present in the modified atmosphere, they are present in an amount of less than 40% by weight or by volume. Preferably, such oxidising fluids are present in the modified atmosphere in an amount of less than 35%, less than 30%, less than 25%, less than 20%, less than 15%, less than 10%, less than 5% or less than 1% by weight or by volume. In certain circumstances, such oxidising fluids may be present in the modified atmosphere in an amount of less than 5000 ppm, less than 2500 ppm, less than 1000 ppm, less than 500 ppm or less than 200 ppm.

Dielectric strength is a measure of the maximum voltage difference that can be applied across a pure material without the material breaking down. At the voltage where the material breaks down, electrons are released from the material and ions and radicals are formed. Thus, the material becomes conductive i.e. it loses its insulating properties. The dielectric strength of gases may be expressed as a value relative to the dielectric strength of air. The following table shows the dielectric strength for various gases relative to air:

| | | Dielectric Strength |
|---|---|---|
| Gas | Formula | Relative to Air |
| Octafluorocyclobutane | C₄F₈ | 3.6 |
| 1,2-Dichlorotetrafluoroethane | CF₂ClCF₂Cl | 3.2 |
| Sulphur hexafluoride | SF₆ | 3 |
| Dichlorodifluoromethane | CF₂Cl₂ | 2.9 |
| Perfluorobutane | C₄F₁₀ | 2.6 |
| Perfluoropropane | C₃F₈ | 2.2 |
| Hexafluoroethane | C₂F₆ | 2.02 |
| Carbon monoxide | CO | 1.2 |
| Nitrogen | N₂ | 1.15 |
| Carbon tetrafluoride | CF₄ | 1.01 |
| Air | mixture | 1 |
| Ammonia | NH₃ | 1 |
| Carbon dioxide | CO₂ | 0.95 |
| Hydrogen sulphide | H₂S | 0.9 |
| Chlorine | Cl₂ | 0.85 |
| Oxygen | O₂ | 0.85 |
| Trifluoromethane | CF₃H | 0.8 |
| Hydrogen | H₂ | 0.65 |
| Sulphur dioxide | SO₂ | 0.3 |
| Argon | Ar | 0.2 |
| Neon | Ne | 0.02 |
| Nitrous oxide | N₂O | 1.3 |

During the plasma treatment in step b. the gases present in the modified atmosphere breakdown to give a mixture of ions, radicals, electrons etc.

As a general principle, gases with a lower dielectric strength are more reactive than gases with a higher dielectric strength, with the exception of the noble gases. Consequently, those gases with a lower dielectric strength may have a greater ability to react with the surface of the polymeric film substrate during the plasma treatment in step b.

Certain oxidising fluids with a relative dielectric strength less than that of air may react with the surface of the polymeric film substrate to the extent that the surface becomes damaged. Consequently, the ability of the polymeric film substrate to adhere to other materials, in particular foils, may be significantly reduced. Oxygen is a specific example of such an oxidising fluid. Without wishing to be bound by any such theory, it is believed that the oxygen ions/radicals formed during plasma treatment may cleave the backbone of the polymer molecules present at the surface of the polymeric film substrate. This may result in the surface of the polymeric film substrate breaking down and becoming oily, which may cause the polymeric film substrate to lose (or severely reduce) its ability to adhere to other materials, in particular foils.

The inventors of the present invention have surprisingly found that where the modified atmosphere comprises oxidising fluids with a relative dielectric strength less than that of air e.g. O₂, CO₂, SO₂, these should be present in the modified atmosphere in an amount of less than 40% by weight or by volume. At this amount, it has unexpectedly been found that the oxidising fluids are able to beneficially functionalise the surface of the polymeric film substrate (as explained later) without substantially damaging it.

The surface chemistry of the polymeric filmic substrate may be affected by the plasma treatment in step b., in particular its functionality, for example the amount of polar chemical species present at the surface of the film. Prior to plasma treatment, the surface of the polymeric film substrate may, or may not, contain polar chemical species at its surface in any significant or substantial amount (above 1% relative atomic concentration for example). A polyolefin film, for example, essentially comprises only carbon-carbon and carbon-hydrogen bonds and is therefore substantially non-polar. On the other hand, a polyester film or an acrylic-coated film for example will already contain polar chemical species, including at its surface.

The precise nature of the chemical functionality engendered at the surface of the film by plasma treatment will depend upon many factors, including the chemical characteristics of the polymeric film substrate itself at its surface, the nature of the modified atmosphere provided during the plasma treatment, the power and duration of the plasma treatment and other ancillary parameters such as the environment, both physical and chemical, in which the polymeric film substrate is treated and/or maintained. Polar fragments may derive from the film itself and/or from the modified atmosphere in which the film is treated. In particular, polar fragments may derive from the modified atmosphere of the plasma treatment, alone or in combination with materials from the polymeric film substrate. For example, when the modified atmosphere of the plasma treatment comprises nitrogen gas, there will likely be polar fragments comprising carbon-nitrogen bonds at the film surface after plasma treatment.

The polar chemical species at the film surface after plasma treatment may comprise one or more of the species selected from: nitrile, amine, amide, hydroxy, ester, carbonyl, carboxyl, ether and oxirane.

The technique of ToF-SIMS spectroscopy has been found to be a satisfactory method for measuring in qualitative terms the surface functionality (in terms of the identities of polar species present at the surface) of the film. However, for quantitative characterisation (in terms of relative atomic concentration of polar species at the film surface), the inventors have found the technique of XPS spectroscopy to be more useful. Other determinative methods will be apparent to the skilled addressee.

The polymeric film substrate may be passed through any number of plasma treatment zones during the plasma treatment, for example 1 to 10 plasma treatment zones may be used. Each plasma treatment zone may have the same or a different modified atmosphere comprising one or more of an inert carrier gas, an oxidising fluid, a reducing fluid and a polar fluid, provided that at least one of the plasma treatment zones has a modified atmosphere in accordance with the invention.

The foil may be contacted with and adhered to the polymeric film substrate using any suitable process known in the art, for example hot foil stamping, cold foil stamping, pressure adhesion or continuous stripe application. The preferred process is continuous stripe application. Continuous stripe application may be carried out using a continuous foil application machine, for example a continuous foil application machine manufactured by Kurz® e.g. Kurz® MHS or KBA OptiNota®, or manufactured by Gietz® e.g. FSA 1060 Foil Commander. During continuous foil application, heat and pressure may be used to adhere the foil to the polymeric film substrate. Any suitable temperature for adhering the foil to the polymeric film substrate may be used, provided that the polymeric film substrate is not substantially deteriorated, for example melted, during the continuous foil application process. For example, the temperature during continuous foil application may be from about 50° C. to about 150° C., from about 70° C. to about 120° C., or from about 80° C. to about 110° C.

The inventors of the present invention have surprisingly found that modified atmosphere plasma treatment of at least one of the surfaces of the polymeric film substrate enhances foil adhesion thereto. The level of adhesion between the polymeric film substrate and the foil is able to pass the rigorous testing of security films e.g. bank notes. In particular, the level of adhesion between the polymeric film substrate and the foil is able to pass the rigorous tests outlined in ISO 9001, these include: chemical resistance tests, crumpling tests, abrasion tests, tearing resistance tests, lightfastness tests, washing machine tests, resistance to ironing tests and foil freezing tests. Due to the enhanced level of adhesion between the polymeric film substrate and the foil, it is possible to use conventional continuous foil application to effectively adhere the polymeric film substrate and the foil to one another, even when the security features and designs of the foil are delicate.

Without wishing to be bound by any such theory, it is believed that the surface of the polymeric film substrate is chemically altered during plasma treatment. In particular, the amount of polar chemical species on the film surface is increased. These polar chemical species may form strong interactions with the foil (particularly with an adhesive layer provided on the foil, where present), for example via hydrogen bonding or ionic bonding, which strongly adhere the polymeric film substrate to the foil.

The polymeric film substrate may comprise a polyolefin, for example polyethylene, polypropylene, polybutylene, mixtures, blends or copolymers (random or block) thereof and/or other known polyolefins. Additionally or alternatively, the polymeric film substrate may comprise a biopolymer, for example cellulose or derivatives thereof, carbohydrate-based polymers or lactic acid based polymers e.g. polylactic acid; a polyurethane; a polyvinylhalide; a polystyrene; a polyester; a polyamide; an acetate; and/or mixtures or blends thereof. Preferably, the polymeric film substrate comprises polypropylene, more preferably biaxially oriented polypropylene (BOPP).

The polymeric film substrate may be made by any process known in the art, including, but not limited to, cast sheet, cast film and blown film. The film may be prepared as a balanced film using substantially equal machine direction (MD) and transverse direction (TD) stretch ratios, or can be unbalanced, where the film is significantly more oriented in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

The polymeric film substrate may be mono-oriented in either the machine or transverse directions. Alternatively, the polymeric film substrate may be biaxially oriented.

The polymeric film substrate may be a mono-layer film, or it may be a multi-layer film. In the latter case, the film may comprise at least one core layer forming a substantial element of the films overall thickness. The multi-layer film may comprise one or more additional layers such as skin layers, coatings, co-extrudates, primer layers, overlaquers and the like.

The skin layers and/or coatings may independently be formed of or comprise a polyolefin material, such as polyethylene, polypropylene, polybutylene, mixtures, blends or copolymers thereof and/or other known polyolefins. Additionally or alternatively, the skin layers and/or coatings may be formed of or comprise a biopolymer, for example cellulose or derivatives thereof, carbohydrate-based polymers or lactic acid based polymers e.g. polylactic acid; a polyurethane; a polyvinylhalide; a polystyrene; a polyester; a polyamide; an acetate; and/or mixtures or blends thereof. The surface of the film substrate that is plasma treated preferably does not comprise an adhesive layer.

The skin layers and/or coatings may have a thickness of from about 0.05 μm to about 5 μm, from about 0.1 μm to about 3 μm, from about 0.2 μm to about 2 μm or from about 0.3 μm to about 1 μm.

The total thickness of the polymeric film substrate may vary depending on the application requirements. For example, the polymeric film substrate may have a thickness of from any one of 1 μm, 5 μm, 10 μm, 15 μm, 20 μm or 30 μm; to any one of 50 μm, 70 μm, 80 μm, 100 μm, 120 μm, 200 μm or 350 μm.

Preferably, the polymeric film substrate is substantially or entirely free from migratory additives. By ‘migratory additives’ we mean those additives which have a tendency to migrate to the surface of a film, causing surface contamination. Migratory additives may comprise one or more of slip promoting additives, anti-static additives and anti-block additives, for example erucamide, calcium stearate and glycerol monostearate.

Migratory additives such as those mentioned above are often added to polymeric film substrates to make handling of the film easier. However, the use of migratory additives in polymeric film substrates has several drawbacks due to their tendency to migrate to the surface of the film, for example the optical properties of the film may be reduced. Additionally, migratory additives may cause the surface of the film to become sticky, which is detrimental to the printability of the film and the ability of the film to adhere to other materials, for example foils.

The foil may comprise a metal foil layer. The metal foil layer may be a metallised layer or a metal foil layer as is commonly understood in the art i.e. a thin sheet of metal usually formed by hammering or rolling a piece of metal. The metal foil layer may comprise copper or aluminium for example. Alternatively, the foil may comprise a non-metallic foil layer, for example Kurz® Transparent KINEGRAM® Overlay (TKO). Additionally, the foil may comprise an adhesive layer on at least one surface of the metal or non-metal foil layer. The adhesive layer may comprise any suitable adhesive known in the art. For example, the adhesive layer may comprise one or more of an acrylic, a urethane, an amine, an amide, an acrylate and an acetate, and/or polymers thereof. The foil may also comprise a cover layer, an embossed layer, a protection layer and/or a release layer. A preferred structure of a foil according to the present invention is: carrier film (such as a biaxiallly orientated polyester film)/release layer/protection layer/embossed layer/metalised layer/cover layer/hot melt adhesive.

Prior to use, the foil may be part of a laminate structure comprising a release film, for example a polyethylene terephthalate film. Where the foil comprises a metallised layer, the laminate structure may be formed by depositing a metallised layer onto the release film, for example using a standard vacuum metallising process. An adhesive layer may then be applied to the exposed surface of the metallised layer.

The foil may be an optically variable device (OVD), a cold foil, a hot stamping foil and/or any suitable foil manufactured by Kurz®, for example Luxor®, Alufin®, Light Line® or SECOBO®.

The OVD may be, for example, a hologram, a diffraction grating image or comprising liquid crystal technology. The OVD may comprise iridescent images, which exhibit various optical effects, for example movement or colour changes, according to the viewing angle.

The process may comprise the additional steps of opacification, embossing, etching, printing and/or overcoating of the polymeric film substrate. Steps b. and c. may be carried out prior to or after one or more of any such additional steps. Preferably, steps b. and c. are carried out prior to any such additional steps. This has the advantage that the security film manufacturer can manufacture the security film at one location and then the film can be transported to a customer at a second location, who can carry out one or more of the additional steps.

Printing of the polymeric film substrate may be carried out by any known process in art, for example, UV Flexo, screen or combination printing, gravure or reverse gravure printing, traditional offset printing, intaglio printing or letterpress printing.

An additional advantage of the present invention is realised when the polymeric film substrate is printed subsequent to the plasma treatment in step b., since the plasma treatment may afford the polymeric film substrate with improved printability, as described in our WO 2013/045930, GB 1305631.2 (GB2512357) and GB 1305632.0 (GB2512358) applications.

The inventors of the present invention have found that there are two primary factors in connection with the properties of the surface of the polymeric film substrate which determine its printability. These are the surface chemistry of the polymeric film substrate on the one hand and its surface energy on the other. Surface chemistry is determinative of the ability of the polymeric film substrate to bind with an ink applied to the surface thereof, whereas surface energy is determinative of the wetting characteristics of an ink applied to the surface. Good adhesion and/or good wettability may be necessary to achieve a polymeric film substrate with improved printability.

The surface chemistry of the polymeric film substrate may be affected by the plasma treatment in step b. as previously discussed. This may enhance the printability of the polymeric film substrate.

Additionally, the surface energy of the polymeric film substrate may be increased by the plasma treatment. The surface energy of the polymeric film substrate immediately after plasma treatment may be at least about 2 dynes/cm, at least about 5 dynes/cm, at least about 8 dynes/cm, at least about 10 dynes/cm, at least about 15 dynes/cm, at least about 20 dynes/cm or at least about 25 dynes/cm higher than the surface energy of the polymeric film substrate immediately before such plasma treatment.

According to a second aspect of the present invention, there is provided a security film obtained or obtainable by means of the process previously outlined.

According to a third aspect of the present invention, there is provided a security document or article comprising the film of the second aspect of the invention.

According to a fourth aspect of the present invention, there is provided a security film comprising a polymeric film substrate having at least one surface comprising functional groups capable of adhering to a foil, wherein the functional groups are inducible on the film surface by means of modified atmosphere plasma treatment, wherein the modified atmosphere comprises at least one inert carrier gas and at least one functional material selected from:

i. one or more oxidising fluids;

ii. one or more reducing fluids; and

iii. one or more polar fluids with the capacity to form ionic or covalent bonds with the at least one surface of the polymeric film substrate,

wherein those oxidising fluids with a relative dielectric strength less than that of air, where present, are in the modified atmosphere in an amount of less than 40% by weight or by volume.

For the avoidance of doubt, all features of the first aspect of the invention may apply to the second, third and fourth aspects of the invention and vice versa.

The invention is further described by way of the following examples, which are by way of illustration only, and are not limiting to the scope of the invention described herein.

### EXAMPLES

### Example 1

A biaxially oriented polymeric film having a core layer of clear polypropylene and coextruded skin layers of a polypropylene copolymer was manufactured by means of a bubble process. The film had a total thickness of 50 μm, with each of the skin layers having an approximate thickness of 0.5 μm.

Eight samples (1 to 8) of the polymeric film substrate were subjected to MADBD treatment under the conditions outlined in Table 1. The polymeric film substrate was passed through four plasma treatment zones during MADBD treatment. For samples 1, 2 and 4 to 8, each of the plasma treatment zones had the same modified atmosphere composed of the components shown in the table. However, for Sample 3, the first plasma treatment zone had a modified atmosphere composed of nitrogen only and the remaining plasma treatment zones had a modified atmosphere composed of all the components shown in the table.

Sample 0 formed the control experiment and was not subjected to MADBD treatment.

TABLE 1

| | Power | Modified Atmosphere | | | | |
|---|---|---|---|---|---|---|
| | (W · | N₂ | N₂O | C₂H₂ | Gap | Speed |
| Sample | m²/min) | (165 Nm³/h) | (ppm) | (ppm) | (Shims) | (m/min) |
| 1 | 65 | Yes | — | — | 2 | 275 |
| 2 | 65 | Yes | 1000 | — | 2 | 275 |
| 3 | 65 | Yes | 500 | 500 | 2 | 275 |
| 4 | 25 | Yes | 500 | 500 | 2 | 275 |
| 5 | 45 | Yes | 500 | 500 | 2 | 275 |
| 6 | 65 | Yes | 500 | 500 | 2 | 275 |
| 7 | 85 | Yes | 500 | 500 | 2 | 275 |
| 8 | 100 | Yes | 500 | 500 | 2 | 200 |

Following MADBD treatment, samples 1 to 8 were left to age for 8 days. A foil was then applied to each of samples 0 to 8 using a foil applicator. The foil was formed of an aluminium layer with an amine-based adhesive layer on one side thereof. Prior to application, the foil had a polyethylene terephthalate release film provided on the opposite side of the aluminium layer to the adhesive layer. The foil was applied to the polymeric film samples using a Kurz® KBA OptiNota® hot foil stamp machine at a speed of 60 m/min and a foiling temperature of 95° C.

Following continuous foil application, each of the samples was tested to see how well the polymeric film substrate adhered to the foil. The test involved applying a strip of Tesa® tape over the foil on the polymeric film substrate and then pulling the tape off at an angle of 45°. The samples were then scored on a scale of 1 to 10. A score of 1 indicating that 100% of the foil was removed from the polymeric film substrate and a score of 10 indicating that 0% of the foil was removed. The results are shown in Table 2 below.

TABLE 2

| Sample | Adhesion Score |
|---|---|
| 0 | 1 |
| 1 | 4 |
| 2 | 3 |
| 3 | 9 |
| 4 | 5 |
| 5 | 7 |
| 6 | 9 |
| 7 | 9 |
| 8 | 8 |

From the results it can be seen that samples 1 to 8 which were MADBD treated, all showed better adhesion between the foil and the polymeric film substrate compared to the control sample.

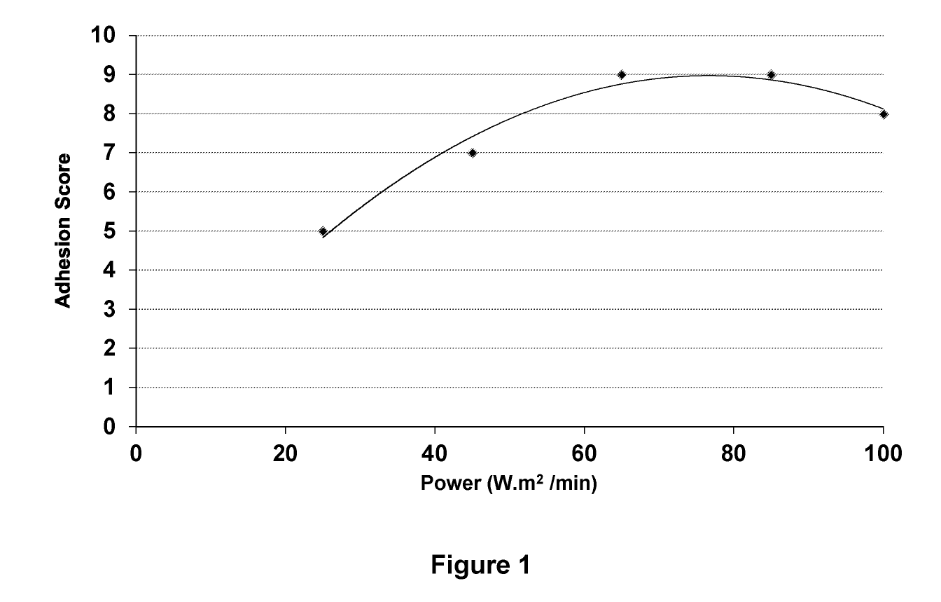

FIG. 1 shows a graph of the adhesion score against power. From the results, it can also be seen that the preferred power range for MADBD treatment may be between about 60 and 90 W.m²/min.

### Example 2

A biaxially oriented polymeric film having a core layer of clear polypropylene and coextruded skin layers of a polypropylene copolymer was manufactured by means of a bubble process. The film also included non-migratory slip additives TL30A75. The film had a total thickness of 50 with each of the skin layers having an approximate thickness of 0.5 μm.

Two samples of the polymeric film substrate were subjected to MADBD treatment under the conditions outlined in Table 3. The polymeric film substrate was passed through four plasma treatment zones during MADBD treatment. Each of the plasma treatment zones had the same modified atmosphere composed of the components shown in the table.

Sample 0 formed the control experiment and was not subjected to MADBD treatment.

TABLE 3

| | Power | Modified Atmosphere | | | | |
|---|---|---|---|---|---|---|
| | (W · | N₂ | N₂O | C₂H₂ | Gap | Speed |
| Sample | m²/min) | (165 Nm³/h) | (ppm) | (ppm) | (Shims) | (m/min) |

| | | | | |
|---|---|---|---|---|
| 1 | 75 | No | 500 | 250 |
| 2 | 75 | No | 500 | 500 |

Following MADBD treatment, samples 1 and 2 were left to age for 8 days. A foil was then applied to each of samples 0 to 2 using continuous foil application. The foil was formed of an aluminium layer with an amine-based adhesive layer on one side thereof. Prior to application, the foil had a polyethylene terephthalate release film provided on the opposite side of the aluminium layer to the adhesive layer. The foil was applied to the polymeric film samples using a Kurz® KBA OptiNota® hot foil stamp machine with 450 DN counter pressure at a variety of speeds and temperatures, as shown in Table 4.

Following continuous foil application, each of the samples was tested to see how well the polymeric film substrate adhered to the foil. The test involved applying a strip of Tesa® tape over the foil on the polymeric film substrate and then pulling the tape off at an angle of 45° immediately after application. The samples were then scored on a scale of 0 to 4, wherein:

4: no change

3: minor change, <10% damaged

2: considerable change, <50% damaged

1: major change, >50% damaged

0: element disappeared, 100% damaged

* inconsistent results (2 or 3 Tape tests)

The results are shown in Table 4 below.

TABLE 4

| No. | Foiling Parameters | Corona/W | Sample | Tape Result |
|---|---|---|---|---|
| 1 | 60 m/min, 100° C. | 0 | 0 | 3(−) |
| 2 | 60 m/min, 100° C. | 70 | 0 | 0 |
| 3 | 60 m/min, 100° C. | 0 | 1 | 0 |
| 4 | 60 m/min, 100° C. | 70 | 1 | 0 |
| 5 | 60 m/min, 100° C. | 150 | 1 | 0 |
| 6 | 60 m/min, 100° C. | 100 | 2 | 3(+) |
| 7 | 60 m/min, 100° C. | 150 | 2 | 3(+) |
| 8 | 60 m/min, 100° C. | 0 | 2 | 0 |
| 9 | 60 m/min, 100° C. | 50 | 2 | 3(−) |
| 10 | 90 m/min, 100° C. | 100 | 2 | 3(+) |
| 11 | 120 m/min, 100° C. | 100 | 2 | 1 |
| 12 | 120 m/min, 100° C. | 150 | 2 | 1 |
| 13 | 120 m/min, 105° C. | 0 | 2 | 0 |
| 14 | 120 m/min, 105° C. | 100 | 2 | 0/3/3* |
| 15 | 120 m/min, 105° C. | 150 | 2 | 1/3/2* |
| 16 | 120 m/min, 110° C. | 0 | 2 | 3 |
| 17 | 120 m/min, 110° C. | 100 | 2 | 1/3/3* |
| 18 | 120 m/min, 110° C. | 150 | 2 | 0 |
| 19 | 120 m/min, 115° C. | 0 | 2 | 1/2* |
| 20 | 120 m/min, 115° C. | 100 | 2 | 3(+) |
| 21 | 120 m/min, 115° C. | 150 | 2 | 0 |
| 22 | 60 m/min, 100° C. | 0 | 1 | 0 |
| 23 | 60 m/min, 100° C. | 100 | 1 | 0 |
| 24 | 60 m/min, 100° C. | 150 | 1 | 0 |
| 25 | 60 m/min, 100° C. | 0 | 2 | 0 |
| 26 | 60 m/min, 100° C. | 100 | 2 | 3-4 |
| 27 | 60 m/min, 100° C. | 150 | 2 | 3-4 |
| 28 | 60 m/min, 100° C. | 0 | 0 | 0-1 |
| 29 | 60 m/min, 100° C. | 100 | 0 | 0-1 |
| 30 | 60 m/min, 100° C. | 150 | 0 | 0-1 |

From the results it can be seen that although the MADBD treatments of samples 1 and 2 are relatively similar, there are some conditions in which sample 2 provides good results while sample 1 fails. Additionally, atmospheric plasma treatment does not support any corona refreshment.

The results also show that at lower speed and lower temperature it seems you will need CDT, though with higher speed and temperature it seems CDT has a negative effect.

1. A process for producing a security film, comprising:
a) forming a polymeric film substrate having first and second surfaces;
b) plasma treating at least one surface of the polymeric film substrate using a modified atmosphere plasma treatment, wherein the modified atmosphere comprises at least one inert carrier gas and at least one functional material selected from:
i) one or more oxidising fluids;
ii) one or more reducing fluids; and
iii) one or more polar fluids with the capacity to form ionic or covalent bonds with the at least one surface of the polymeric film substrate,
wherein those oxidising fluids with a relative dielectric strength less than that of air, where present, are in the modified atmosphere in an amount of less than 40% by weight or by volume; and
c) contacting a foil with the at least one plasma treated surface of the polymeric film substrate such that the foil adheres to the polymeric film substrate.

2. The process according to claim 1, wherein the modified atmosphere plasma treatment is an atmospheric pressure plasma treatment.

3. The process according to claim 2, wherein the modified atmosphere plasma treatment is MADBD treatment.

4. The process according to claim 1, wherein the inert carrier gas comprises a noble gas and/or nitrogen.

5. The process according to claim 1, wherein the one or more reducing fluids comprises acetylene, ethylene, hydrogen and/or silane.

6. The process according to claim 1, wherein the one or more polar fluids with the capacity to form ionic or covalent bonds with the at least one surface of the polymeric film substrate comprises ammonia and/or sulphur hexafluoride.

7. The process according to claim 1, wherein the one or more oxidising fluids comprises oxygen, ozone, carbon dioxide, carbon monoxide, a nitric oxide, a nitrous oxide, sulphur oxide, sulphur dioxide and/or sulphur trioxide.

8. The process according to claim 1, wherein the one or more oxidising fluids with a relative dielectric strength less than that of air are present in the modified atmosphere in an amount of less than 35%, less than 30%, less than 25%, less than 20%, less than 15%, less than 10%, less than 5% or less than 1% by weight or by volume.

9. The process according to claim 1, wherein the one or more oxidising fluids with a relative dielectric strength less than that of air are present in the modified atmosphere in an amount of less than 5000 ppm, less than 2500 ppm, less than 1000 ppm, less than 500 ppm, less than 200 ppm or less than 100 ppm.

10. The process according to claim 1, wherein step c is carried out using a foil applicator.

11. The process according to claim 10, wherein the foil application involves an increased temperature, a dwell time and an increased pressure.

12. The process according to claim 11, wherein the temperature during foil application is:
a) from about 50° C. to about 150° C.;
b) from about 70° C. to about 120° C.; or
c) from about 80° C. to about 110° C.

13. The process according to claim 1, wherein the polymeric film substrate comprises a polyolefin; a biopolymer; a polyurethane; a polyvinylhalide; a polystyrene; a polyester; a polyamide; an acetate; and/or mixtures or blends thereof.

14. The process according to claim 13, wherein the polyolefin is selected from polyethylene, polypropylene, polybutylene, mixtures, blends or copolymers thereof.

15. The process according to claim 14, wherein the polypropylene is biaxially oriented polypropylene.

16. The process according to claim 1, wherein the polymeric film substrate comprises one or more skin layers and/or coatings.

17. The process according to claim 16, wherein the one or more skin layers and/or coatings comprise a polyolefin material; a polyurethane; a polyvinylhalide; a polystyrene; a polyester; a polyamide; an acetate; and/or mixtures or blends thereof.

18. The process according to claim 16, wherein the one or more skin layers and/or coatings have a thickness of:
a) from about 0.05 μm to about 5 μm;
b) from about 0.1 μm to about 3 μm;
c) from about 0.2 μm to about 2 μm; or
d) from about 0.3 μm to about 1 μm.

19. The process according to claim 1, wherein the total thickness of the polymeric film substrate is from any one of 1 μm, 5 μm, 10 μm, 15 μm, 20 μm or 30 μm; to any one of 50 μm, 70 μm, 80 μm, 90 μm, 100 μm, 120 μm, 200 μm or 350 μm.

20. The process according to claim 1, wherein the polymeric film substrate is substantially or entirely free from migratory additives.

21. The process according to claim 1, wherein the foil comprises a metal foil layer, optionally wherein the metal foil layer is a metallised layer.

22. The process according to claim 21, wherein the metal foil layer comprises copper or aluminium.

23. The process according to claim 1, wherein the foil comprises a non-metallic foil layer.

24. The process according to claim 21, wherein the foil additionally comprises an adhesive layer on at least one surface of the metal or non-metal foil layer, optionally wherein the adhesive layer comprises one or more of an acrylic, a urethane, an amine, an amide, an acrylate and an acetate, and/or polymers thereof.

25. The process according to claim 1, wherein the foil is an optically variable device, a cold foil, a hot stamping foil and/or any suitable foil manufactured by Kurz®, in particular Luxor®, Alufin®, Light Line® or SECOBO®.

26. The process according to claim 1, wherein the process comprises one or more of the following additional steps: opacification, embossing, etching, printing and overcoating of the polymeric film substrate.

27. The process according to claim 26, wherein the process steps b and c are carried out prior to one or more of any such additional steps.

28. The process according to claim 26, wherein the polymeric film substrate is printed using UV Flexo, screen or combination printing; gravure or reverse gravure printing; traditional offset printing; intaglio printing; or letterpress printing.

29. The process according to claim 1, wherein the surface energy of the polymeric film substrate immediately after plasma treatment is:
a) at least about 2 dynes/cm;
b) at least about 5 dynes/cm;
c) at least about 8 dynes/cm;
d) at least about 10 dynes/cm;
e) at least about 15 dynes/cm;
f) at least about 20 dynes/cm; or
g) at least about 25 dynes/cm
higher than the surface energy of the polymeric film substrate immediately before such plasma treatment.

30. A security film obtained or obtainable by means of the process of claim 1.

31. A security document or article comprising the security film of claim 30.

32. A security film comprising a polymeric film substrate having at least one surface comprising functional groups capable of adhering to a foil, wherein the functional groups are inducible on the film surface by means of modified atmosphere plasma treatment, wherein the modified atmosphere comprises at least one inert carrier gas and at least one functional material selected from:
i) one or more oxidising fluids;
ii) one or more reducing fluids;
iii) one or more polar fluids with the capacity to form ionic or covalent bonds with the at least one surface of the polymeric film substrate,
wherein those oxidising fluids with a relative dielectric strength less than that of air, where present, are in the modified atmosphere in an amount of less than 40% by weight or by volume.

33. The security film according to claim 32, wherein the modified atmosphere plasma treatment is MADBD treatment.
